(19) United States
(12) Patent Application Publication
(10) Pub. No.: US 2019/0063143 A1
(43) Pub. Date: Feb. 28, 2019

(54) GARBAGE BIN CABINET DOOR BIB

(71) Applicant: Mary E. Digan, Toms River, NJ (US)

(72) Inventor: Mary E. Digan, Toms River, NJ (US)

(21) Appl. No.: 15/691,843

(22) Filed: Aug. 31, 2017

(51) Int. Cl. E06B 3/70; A47B 88/919; A47C 31/11

(52) U.S. Cl. CPC E06B 3/7001; A47C 31/11; A47B 88/919

(57) ABSTRACT

The invention is a drape that is used to decorate and protect the finish of cabinet doors and drawers. It is placed around the upper edge of a door or drawer and drapes over the upper edge acting as a protective and decorative cover.

### BACKGROUND

### Field of the Invention

The present invention is directed to shield a garbage bin cabinet door (especially the back of it) from drips and spills (which can dry and cause deterioration of the cabinet door finish over time when cleaned repeatedly). The invention is placed around a top portion of a cabinet door or drawer, drapes over onto the other side, and extends from there several inches (and doesn't interfere with door's/drawer's closure). This acts as a shield to protect the finish of the door where touched most, and to prevent any garbage/food from dropping onto the top edge and/or from rolling down the front or back side of the door. Continual cleaning/scrubbing of cabinetry tends to wear down the finish prematurely.

The present invention not only allows a user to add decorative and protective value to their cabinetry doors and drawers but it specifically prevents spills and drips from going behind the garbage bin door/drawer, It also allows a user to highlight where their trash bin is for visitors (which is often hard to find given there is typically no way to find a trash bin without opening several). Without said invention, users are more likely to have to clean off dried spills from their cabinetry more often. The user can instead use said invention, wash it when needed, and replace it instead of having to scrub their cabinetry. The lack of a device on the market has prompted me to create said invention.

### Description of the Related Art

See drawings below of said invention—which is positioned on a cabinet door/drawer.

### BRIEF DESCRIPTION OF THE DRAWINGS

FIG. 1, FIG. 2 and FIG. 3 are frontal views showing my new invention—which is a versatile garbage bin door bib. The bib is an elasticized (or fitted) cap and placed around a top edge of a door. See FIG. 1 which depicts the frontal view of an elasticized version. See FIGS. 2 and 3 which depicts fitted versions of the bib. The bib has a tapered backflap which allows it to drape over the top edge of the door and extends several inches down the back of the door (see FIG. 4).

In the front it will have at least three possible “looks” or designs as shown in FIGS. 1-3;

FIG. 1 is a simple bib with a uniform length across (a)—the length of the bib may appear shorter in the middle because of the position of the handle. The elasticized construction allows it to move to accommodate handles which may be positioned higher or lower on the door.

FIG. 2 is an uneven type bib with the shorter part in the middle (b) which grows progressively longer out from the center toward the outer edges.

FIG. 3 incorporates the top portion of the bib from FIG. 1 but includes a sash (c) (longer strips of fabric/material) which may be attached at the sides and can be tied in the front for a more decorative look. This additional sash/bow may be added to the versions above to create more decorative and protective value.

FIG. 4 is a view behind the cabinet door which also depicts one trash bin. One can see the tapered nature of the back flap (d) and how when used with a trash bin door it will actually overlap with the top portion of the bin and enter part of the bin to protect the back of the door.

FIG. 5 depicts another embodiment—that of a bib that originates from a bag that will sit in the bin. This embodiment has one elongated side that can slip over the cabinet door (e) thus accomplishing the same shield type effect as described previously. It may or may not include a sash.

FIG. 6 depicts an additional embodiment where a tapered end would actually be a much longer piece of material which would extend over the trash bin entirely creating a bib for the door. Trash would pass through the cloth by way of a hole (f) in the material.

### DETAILED DESCRIPTION

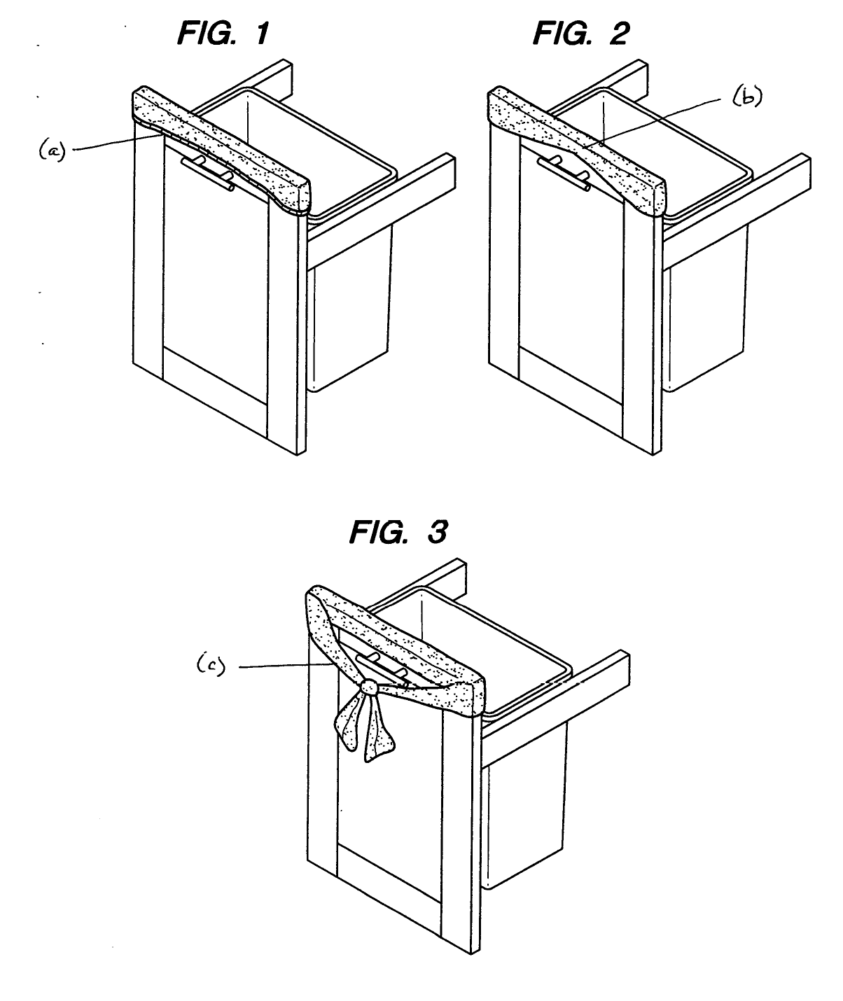

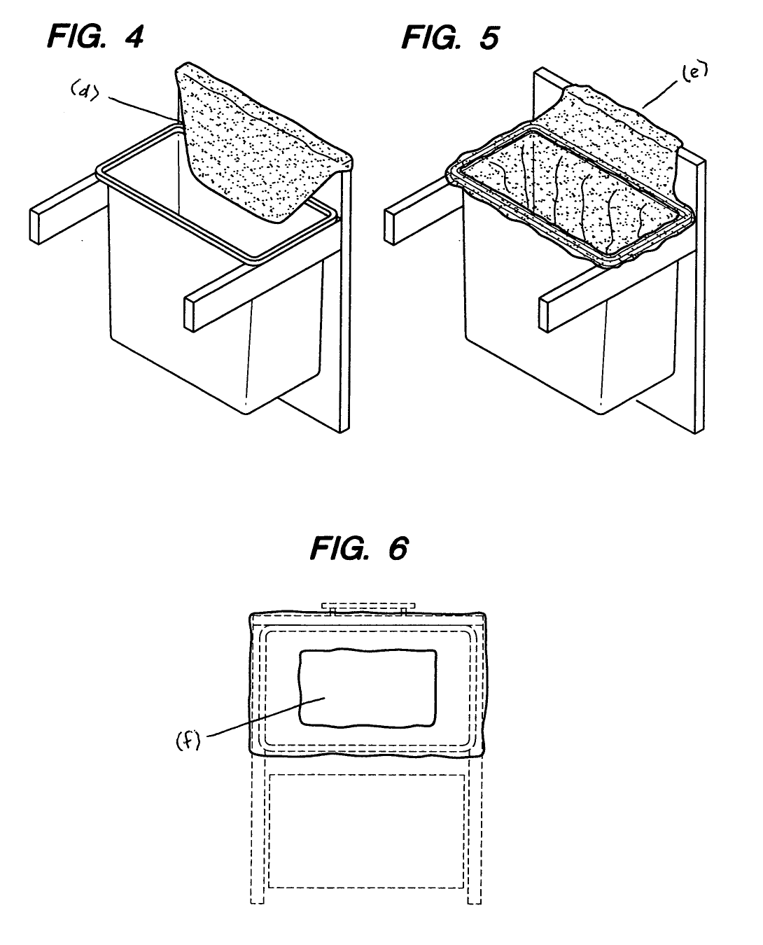

The invention, such as a garbage bin door bib (1) is placed onto a top portion of the door (2) as show in FIGS. 1, 2 and 3. And comprises a waterproof polyurethane laminate fabric “cap” that covers the top edge of the door/drawer (a) and of a back flap (long tapered end) which drapes over down the inside of the door. (b). It may utilize elastic or may simply be fitted to allow the user to place it on the upper edge of the door securely albeit temporarily so that the door may be protected from fingerprints, food stains, or wear and tear.

One version has a uniform length, and another version has a more draping effect in front, however, the invention may be styled differently to combine the two styles and still fall within this spec.

The look or construction of invention may be amended to be longer, shorter, to incorporate other elements not stated here, may be constructed a bit differently (out of different materials, including non-waterproof materials, or be a part thereof) yet accomplish the same aim, and still fall within this spec.

Extending from the top portion of said invention is a symmetrical isosceles-trapezoid-shaped extension which hangs backwards into the trash bin to protect the door from the top edge downwards. This mainly protects from spills and splashing of food/liquids, etc that can roll down the door. The draping piece which extends down the back of the door or drawer (and into the bin, when placed on a trash bin door) may be of a different shape or proportion, and still fall within this spec.

A bow (or other decorative element) (c) may or may not be included/attached to said invention (it may be included as a separate sash or be attached to the sides of the top elasticized portion of invention, and tied at front. When a separate sash, it would be strung under the drape in back and tied at the front of the cabinet door so that it would not interfere with the function of the drape.)

Alternatively, as noted in the drawings, another embodiment of this invention is to have the top portion of invention extend to a much longer draping piece length (d) so that it can completely cover the top of the trash bin nearest to the door, and garbage would pass through a hole provided in the longer extension of material (e).

This spec also includes another embodiment comprising an even longer extension of the bib drape (f) to include a bag—which would sit in the bin instead of just dipping into the bin.

The invention can be used on cabinet doors and, drawers.

The invention is made from waterproof polyurethane laminate material and elastic, however, the invention may be made from other materials, or be constructed in another manner, and all such versions shall fall within this spec.

The invention's purpose is to provide protective, covering and decorative value to cabinet doors and drawers; however, this invention may be utilized for other uses not yet known, and those uses shall also fall under this spec.

The invention may be utilized with or without a sash. The sash/bow may be attached to the top portion of the invention or be separate. However, even when without a sash the top portion is covered under this spec as the essential portion of the invention. The sash is an ornamental addition which helps to provides the door extra coverage and thus it offers protective value when coupled with the top portion of said invention.

1. A garbage bin door bib or drape comprising:
An elasticized cap that can be placed around a top portion of a cabinet door to protect the top of the door from spills and drips

2. The invention of claim 1 further comprising a backflap (or a tapered end) which drapes over onto the back side of the door preventing wills from seeping behind the garbage bin door.
